(19) United States
(12) Patent Application Publication
(10) Pub. No.: US 2012/0182722 A1
(43) Pub. Date: Jul. 19, 2012

(54) ILLUMINATED VEHICLE EMBLEM

(76) Inventor: Ming-Yuan WU, Taipei City (TW)

(21) Appl. No.: 13/007,195

(22) Filed: Jan. 14, 2011

(51) Int. Cl. F21L 4/00; F21V 3/00

(52) U.S. Cl. 362/157; 362/311.02

(57) ABSTRACT

An illuminated emblem comprising a back cover for protection from weather, a top cover attaching to the back cover, at least one light emitting diode (LED) disposed between the top cover and the bottom cover, and at least one light affecting piece attaching to the top cover is disclosed. The top cover comprises a transparent, semi-transparent, translucent, or colored material. The at least one light affecting piece blocks light, colors light, or affects brightness of the light emitted by the at least one LED light source. Various light patterns are created by shapes of the light affecting pieces. Light emitted by the LED light source shines through the top cover and is affected by the composition of the top cover. At the same time, light emitted by the LED light source shines onto the light affecting piece and is affected by the light affecting piece.

### BACKGROUND OF THE INVENTION

1. Field of the Invention

The present invention relates to emblems. More specifically, the present invention discloses an illuminated emblem for a motor vehicle.

2. Description of the Prior Art

Automobile manufacturers routinely mount emblems on their vehicle. The emblems are typically the manufacturer's logo or the vehicle model number.

One type of conventional emblem is a flat mounted emblem. This type of emblem consists of a single piece of flat metal that is chrome plated or painted. Once the emblem has been formed and the finish has been applied, the emblem is mounted flat on a side or back of the vehicle. The emblem is typically attached to the vehicle with screws or adhesive. While the flat mounted emblem is visible during daylight it cannot be seen at night. This greatly reduces the usefulness of the emblem.

Another type of conventional emblem is the upright mounted emblem. The upright mounted emblem consists of a logo part similar to the flat mounted emblem but the logo part has holes to allow air to flow through. The upright mounted emblem also has a stand and mounting base attached to the bottom of the logo part. After the metal logo part has been formed and chrome plated the mounting base is attached to the front top hood of the car. While the upright mounted emblem is slightly more visible at night than the flat mounted emblem, the upright mounted emblem can easily be broken off of the car. This results in expensive automobile repair charges.

As described above the conventional emblems have numerous disadvantages.

Therefore, there is need for an improved vehicle emblem with a light source to more effectively display a logo or mark.

### SUMMARY OF THE INVENTION

To achieve these and other advantages and in order to overcome the disadvantages of the conventional methods in accordance with the purpose of the invention as embodied and broadly described herein, the present invention provides an illuminated emblem that can be attached to a vehicle or an object.

The illuminated emblem comprises a back cover for protection from weather, a top cover attaching to the back cover, at least one light emitting diode (LED) disposed between the top cover and the bottom cover, and at least one light affecting piece attaching to the top cover.

The top cover comprises a transparent, semi-transparent, or translucent material. The at least one light affecting piece blocks light, colors light, or affects brightness of the light emitted by the at least one LED light source.

Various patterns or logos are created by shapes of the light affecting pieces. Light emitted by the LED light source shines through the top cover and is affected by the composition of the top cover. For example, if the top cover comprises a translucent material the light is diffused and made more uniform. At the same time, light emitted by the LED light source shines onto the light affecting piece and is affected by the light affecting piece. For example, if the light affecting piece comprises an opaque material the light is blocked. If the light affecting piece comprises a colored material the light is colored.

The illuminated emblem in some embodiments comprises a transparent layer, a diffusion layer, a color piece and a light emitting diode (LED) light source. The transparent layer is a piece of transparent material. The diffusion layer diffuses the light emitted by the LED light source before or after entering the transparent layer.

The color piece blocks, colors, or affects the brightness of light emitted by the illuminated emblem via the color piece. Different effects can be achieved by utilizing different materials or colors for the color piece. The shape of the color piece or color pieces is designed to provide information to people who look at the emblem. For example, the shape of the color piece is a car manufacturer's logo or a car model logo or name.

A color layer is provided on the transparent layer for affecting the color of the emitted light. Patterns in the color layer further add visual effects for the illuminated emblem.

A bearing module is provided below the transparent layer. The bearing module allows the transparent layer and/or the color piece to rotate. For example, while the vehicle is moving the color piece can spin. Another example is if a color layer is provided on the transparent layer in a special pattern, when the car is moving the transparent layer spins and the color piece remains stationary. Using different variations allows numerous special visual effects to be achieved. The illuminated emblem is constructed so that the color piece and transparent layer independently or together rotate or remain stationary.

A solar cell and battery are provided to power the LED light source to alleviate power drain on the vehicles battery.

Utilizing the illuminated emblem of the present invention allows the emblem to be seen whenever the emblem is turned on. As a result, the emblem can be seen in darkness such as at night or in a tunnel.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIGS. 1A-1B are drawings illustrating side views of an illuminated emblem according to embodiments of the present invention;

FIGS. 2A-2B are drawings illustrating side views of an illuminated emblem with color layer according to embodiments of the present invention;

FIGS. 3A-3B are drawings illustrating side views of an illuminated emblem with color layer according to embodiments of the present invention;

FIGS. 4A-4H are drawings illustrating side views of an illuminated emblem with color piece according to embodiments of the present invention;

FIGS. 4I-4J are drawings illustrating front views of an illuminated emblem with color piece according to embodiments of the present invention;

FIG. 5 is a drawing illustrating a side view of an illuminated emblem with inset LED light source according to an embodiment of the present invention;

FIG. 6 is a drawing illustrating a side view of an illuminated emblem with bearing module according to an embodiment of the present invention;

FIG. 7A is a drawing illustrating a top view of an illuminated emblem according to an embodiment of the present invention;

FIG. 7B is a drawing illustrating a cross sectional view of an illuminated emblem according to an embodiment of the present invention; and

FIG. 8 is a drawing illustrating a cross sectional view of a rotatable illuminated emblem according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

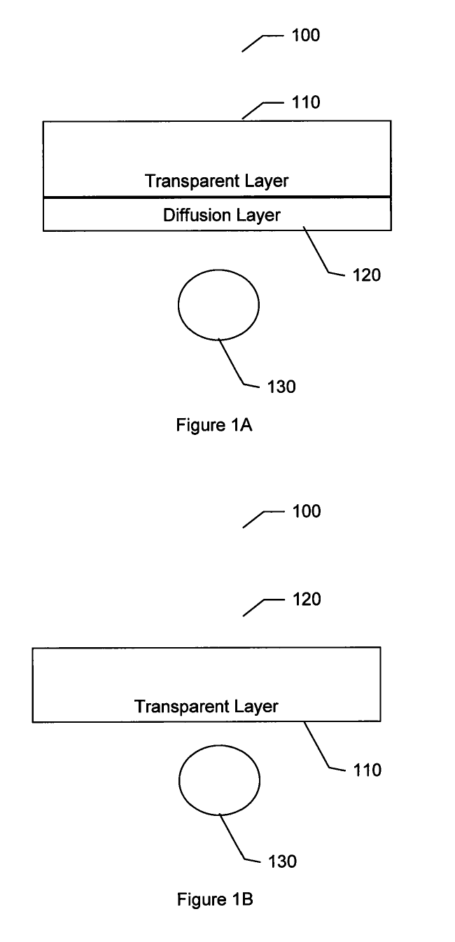

Refer to FIGS. 1A-1B, which are drawings illustrating side views of an illuminated emblem according to embodiments of the present invention.

As shown in FIGS. 1A and 1B the illuminated emblem 100 comprises a transparent layer of material 110, a diffusion layer 120, and a light emitting diode 130. In the embodiment illustrated in FIG. 1A the diffusion layer 120 is on the underside or below the transparent layer 110. The LED light source 130 when illuminated or turned on shines light through the diffusion layer 120 and the transparent layer 110. The diffusion layer 120 diffuses the light so that the light exiting the transparent layer 110 is more uniform in brightness. Without a diffusion layer 120 the LED 130 would be visible and the emitted light would not be uniform throughout the emblem 100.

In the embodiment illustrated in FIG. 1B the diffusion layer 120 is above the transparent layer 110. The LED light source 130 shines light into and through the transparent layer 110 and the light is diffused by the diffusion layer 120 before exiting the emblem 100.

In both FIG. 1A and FIG. 1B the diffusion layer 120 is, for example, a film, sputtering, or a separate piece of material adhered to the transparent layer 110.

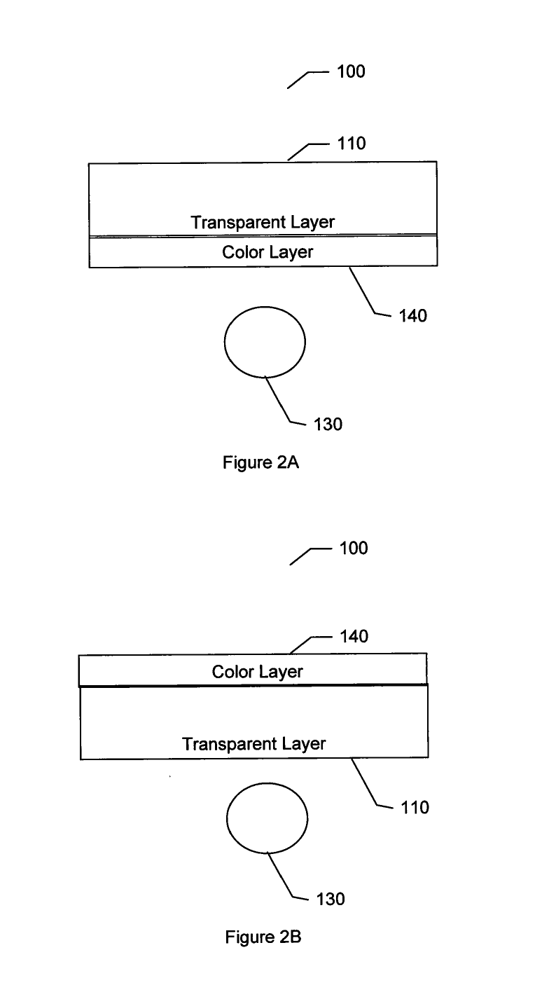

Refer to FIGS. 2A-2B, which are drawings illustrating side views of an illuminated emblem with color layer according to embodiments of the present invention.

In the embodiments illustrated in FIGS. 2A and 2B the illuminated emblem 100 further comprises a color layer 140. In FIG. 2A the color layer 140 is on under the transparent layer 110. Light emitted by the LED 130 shines into the color layer 140 and is colored. The colored light then travels through the transparent layer 110 and then exits the emblem 100.

In FIG. 2B the color layer 140 is above the transparent layer 110. In this embodiment the light emitted by the LED 130 enters and passes through the transparent layer 110. The light is then colored by the color layer 140 before exiting the emblem 100.

In embodiments of the present invention a diffusion layer is added below the color layer, above the color layer, or between the color layer and the transparent layer. In some embodiments of the present invention the color layer acts as a diffusion layer to diffuse the light.

The color layer 140 is, for example, a film, printing, or a separate piece of material. The color layer 140 can be formed with a pattern or shape to affect the light.

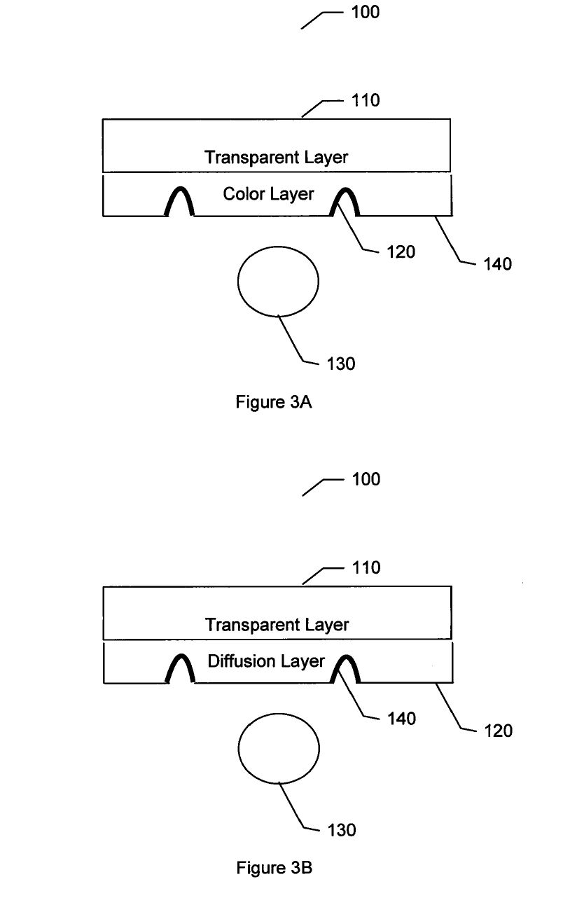

Refer to FIG. 3A, which is a drawing illustrating a side view of an illuminated emblem with color layer according to an embodiment of the present invention.

In the embodiment illustrated in FIG. 3A the illuminated emblem 100 comprises a color layer 140 below the transparent layer 110. A pattern is formed in the bottom of the color layer 140. A diffusion layer 120 or layers is provided in the pattern or indentations in the color layer 140. Due to the pattern the thickness of the color layer 140 varies. As a result, the light emitted by the emblem 100 is affected in color or intensity.

Refer to FIG. 3B, which is a drawing illustrating a side view of an illuminated emblem with color layer according to an embodiment of the present invention.

In FIG. 3B a diffusion layer 120 is below the transparent layer 110. A pattern is formed in the bottom of the diffusion layer 120. A color layer 140 is provided in the pattern in the diffusion layer 120. In this embodiment the emitted light is colored in the shape of the pattern. For example, if the pattern is a “W” and the color layer 140 is red, a red “W” will be visible in the illuminated emblem 100.

The color layer 140 can be a single color or multiple colors. Also, the color layer 140 can vary in thickness further affecting the color and brightness of the light.

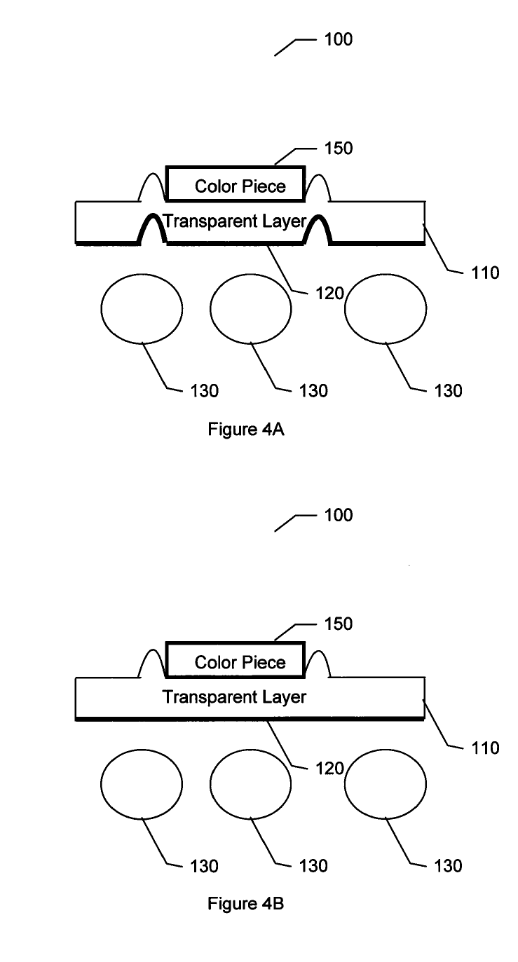

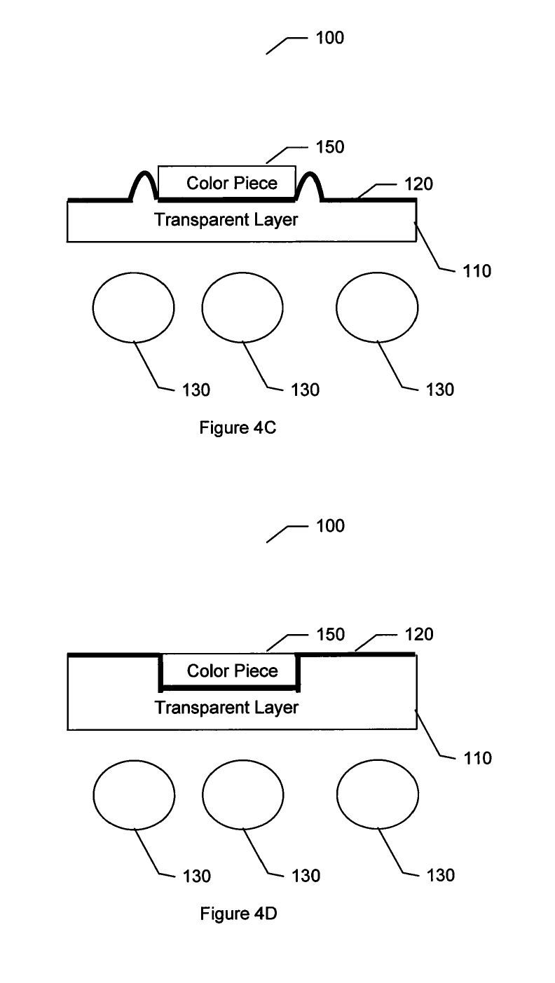

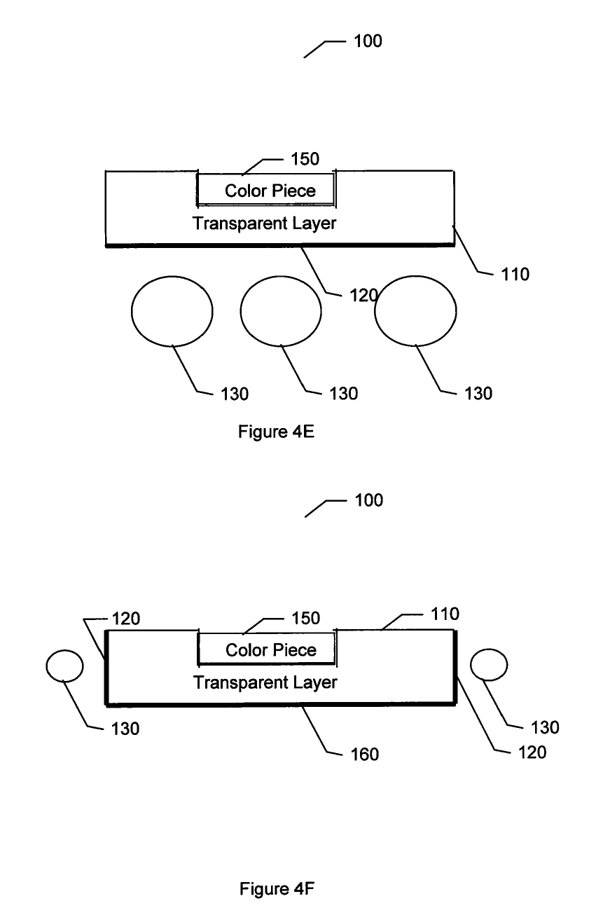

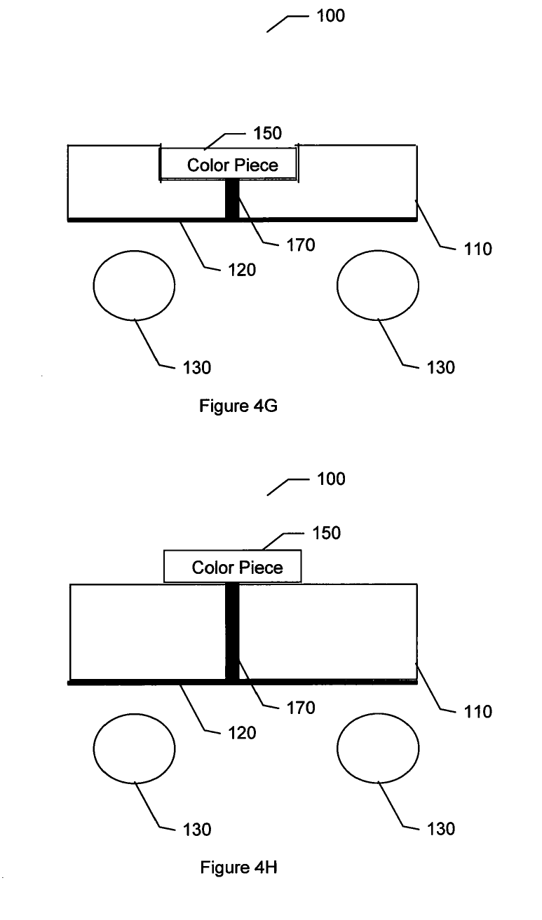

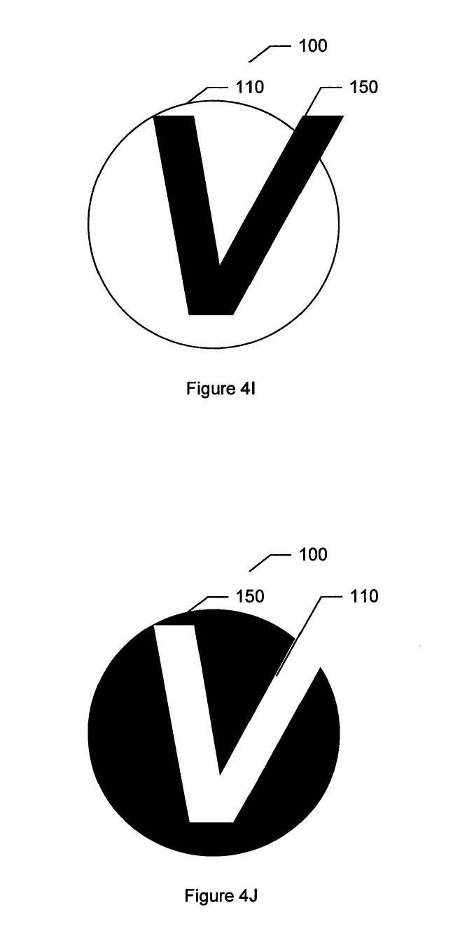

Refer to FIG. 4A, which is a drawing illustrating a side view of an illuminated emblem with color piece according to an embodiment of the present invention.

In the embodiment illustrated in FIG. 4A the illuminated emblem 100 comprises a transparent layer 110. A pattern is formed in the back of the transparent layer 110 and a diffusion layer 120 is provided below the transparent layer 110. The emblem 100 further comprises a color piece 150 or a plurality of color pieces above the transparent layer 110. The top of the transparent layer 110 further comprises a raised pattern relating to the color piece 150.

The color piece 150 is, for example, made of an opaque or semi-opaque material. Light emitted by the plurality of LEDs 130 is diffused by the diffusion layer 120 travels through the transparent layer and either exits the emblem 100 via the transparent layer 110 or the color piece 150. If the light enters the color piece 150 the emitted light will be affected. For example, if the color piece 150 is opaque light will be blocked and only the light emitted from the transparent layer 110 will be visible. Alternatively, if the color piece 150 is a semi-opaque color the emitted light from the color piece 150 will be colored light in the shape of the color piece 150. Further, the thickness of the color piece affects the color and intensity of the emitted light.

It should be understood that the edges of the color piece 150 and the raised pattern in the transparent piece 110 can be contoured to match each other.

The raised pattern and the indented pattern in the transparent piece also affect the emitted light. Further effects are possible by varying the depth and height of the patterns. The raised pattern also provides protection for the color piece to prevent dislodging.

Refer to FIG. 4B, which is a drawing illustrating a side view of an illuminated emblem with color piece according to an embodiment of the present invention.

In this embodiment of the present invention the back of the transparent piece 110 is flat and does not have a pattern in the back. The diffusion layer 120 is provided below the flat back of the transparent layer 110.

Refer to FIG. 4C, which is a drawing illustrating a side view of an illuminated emblem with color piece according to an embodiment of the present invention.

The embodiment in FIG. 4C is similar to the embodiment in FIG. 4B. However, in this embodiment the diffusion layer 120 is provided above the transparent layer 110.

Refer to FIG. 4D, which is a drawing illustrating a side view of an illuminated emblem with color piece according to an embodiment of the present invention.

In the embodiment illustrated in FIG. 4D an indented pattern is formed in the top of the transparent layer 110. The indented pattern is formed to match the shape of the color piece 150. By inserting the color piece 150 into the transparent layer 110 more protection is provided for the color piece 150.

A diffusion layer 120 is provided above the transparent layer 110 and between the transparent layer 110 and the color piece 150.

Refer to FIG. 4E, which is a drawing illustrating a side view of an illuminated emblem with color piece according to an embodiment of the present invention.

In this embodiment the diffusion layer 120 is provided below the transparent layer 110.

Refer to FIG. 4F, which is a drawing illustrating a side view of an illuminated emblem with color piece according to an embodiment of the present invention.

In the embodiment illustrated in FIG. 4F the LED light sources 130 are positioned on the sides of the transparent layer 110. A diffusion layer 120 is provided between the LEDs 130 and the transparent layer 110. A reflective layer 160 is provided below the transparent layer 160. Light emitted by the LED 130 enters the transparent layer 110 via the diffusion layer 120. The light exits the transparent layer 110 or the color piece 150 or is reflected by the reflective layer 160 before exiting the transparent layer 110 or the color piece 150.

Positioning the LEDs 130 on the edge of the transparent layer 110 rather than the back allows the illuminated emblem to be thinner.

Refer to FIG. 4G, which is a drawing illustrating a side view of an illuminated emblem with color piece according to an embodiment of the present invention.

The illuminated emblem 100 in this embodiment further comprises a fastener 170 for holding the color piece 150 and the transparent piece 110 together. The fastener 170 comprises, for example, a screw, bolt, or post. Additionally, the fastener 170 can provide a means of attaching the illuminated emblem 100 to the vehicle.

Refer to FIG. 4H, which is a drawing illustrating a side view of an illuminated emblem with color piece according to an embodiment of the present invention.

In FIG. 4H the color piece 150 is not inset in an indentation in the transparent piece 110 as in FIG. 4G. In the embodiment illustrated in FIG. 4H the color piece 150 is above the flat top of the transparent piece 110.

Refer to FIG. 4I, which is a drawing illustrating a front view of an illuminated emblem with color piece according to an embodiment of the present invention.

As illustrated in FIG. 4I, when the LED light source is turned on light is emitted from the transparent layer 110 and is, for example, blocked, colored, or dimmed by the color piece 150.

Refer to FIG. 4J, which is a drawing illustrating a front view of an illuminated emblem with color piece according to an embodiment of the present invention.

The opposite effect of FIG. 4I is illustrated in FIG. 4J. In this way, either a positive or negative pattern or shape is achieved.

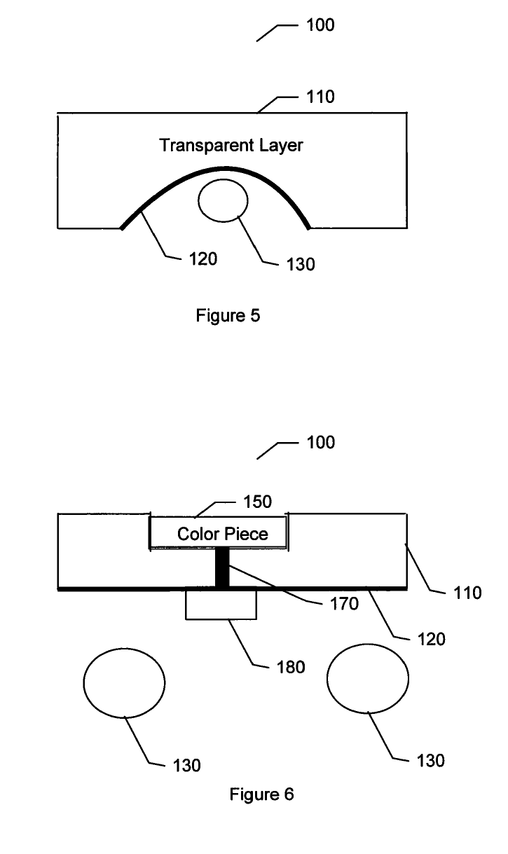

Refer to FIG. 5, which is a drawing illustrating a side view of an illuminated emblem with inset LED light source according to an embodiment of the present invention.

In the embodiment illustrated in FIG. 5 the LED light source 130 is inset in an indentation in the transparent layer. Insetting the LED 130 allows the illuminated emblem to be thinner.

Refer to FIG. 6, which is a drawing illustrating a side view of an illuminated emblem with bearing module according to an embodiment of the present invention.

In FIG. 6 the illuminated emblem 100 further comprises a bearing module 180 below the transparent layer 110. The bearing module 180 allows the transparent layer 110 and/or the color piece 150 to rotate. For example, while the vehicle is moving the color piece can spin. Another example is if a color layer is provided on the transparent layer in a special pattern such as a spiral, when the car is moving the transparent layer spins and the color piece remains stationary. Using different variations allows numerous special visual effects to be achieved. Note that the embodiment illustrated in FIG. 6 comprises an inset color piece 150. In other embodiments the illuminated emblem is constructed so that the color piece and transparent layer independently or together rotate or remain stationary.

In some embodiments of the present invention the surface or design of the transparent layer and/or the color piece are formed to facilitate rotation or movement. For example, fins are provided on the transparent layer or the color piece to catch more air.

In an embodiment of the present invention the illuminated emblem further comprises a solar cell and battery for providing a power supply to the LED light sources.

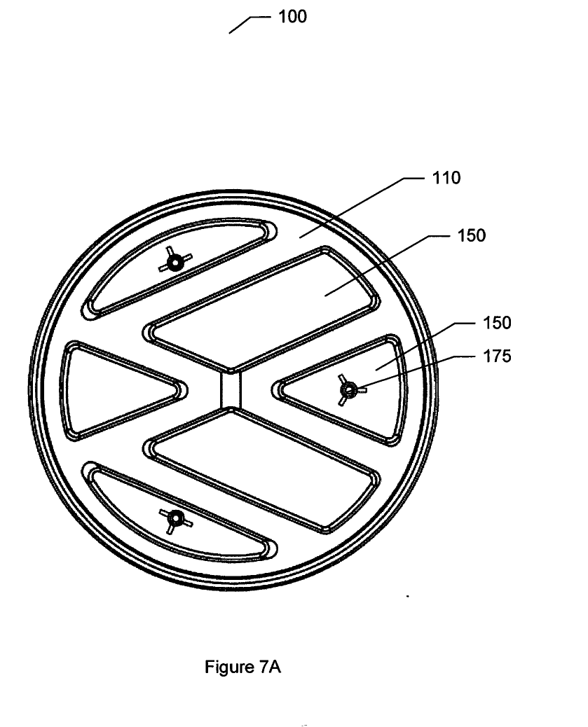

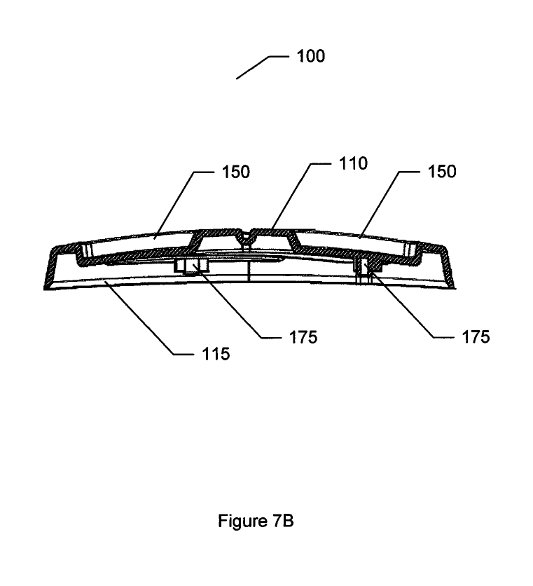

Refer to FIG. 7A, which is a drawing illustrating a top view of an illuminated emblem according to an embodiment of the present invention and to FIG. 7B, which is a drawing illustrating a cross sectional view of an illuminated emblem according to an embodiment of the present invention.

In the embodiment illustrated in FIGS. 7A-7B the illuminated emblem 100 comprises a back cover 115 for protection from weather, a top cover 110 attaching to the back cover 115, at least one light emitting diode (LED) disposed between the top cover 110 and the bottom cover 115, and at least one light affecting piece 150 attaching to the top cover 110.

At least one fastener hole 175 is provided for attaching the light affecting piece 150 to the top cover 110 or for mounting the illuminated emblem 100 to a vehicle, or for attaching the light affecting piece 150 to the top cover 110 and for mounting the illuminated emblem 100 to a vehicle.

In an embodiment of the present invention an LED printed circuit board is provided for controlling operation of the LEDs. For example, operations such as turn on, turn off, dim light, increase brightness, increase blinking speed, decrease blinking speed, change color scheme, emit light pattern, etc. For example, color schemes are provided so that the LEDs cycle through various colors to create a colored light show or light patterns are provided so that the appropriate LEDs are turned on to create a pattern in the emitted light.

In previous embodiments described above, a transparent layer, a diffusion layer, and a color layer are provided. In the embodiment illustrated in FIG. 7A-7B the top cover 110 provides the utility of the transparent layer, diffusion layer, the color layer, or a combination of the transparent layer, diffusion layer, and the color layer. As a result, production of the illuminated emblem is simplified.

The top cover comprises a transparent, semi-transparent, or translucent material. In some embodiments the top cover comprises a colored material for affecting the color of the light.

The at least one light affecting piece blocks light, colors light, or affects brightness of the light emitted by the at least one LED light source.

Various patterns or logos are created by shapes of the light affecting pieces. Light emitted by the LED light source shines through the top cover and is affected by the composition of the top cover. For example, if the top cover comprises a translucent material the light is diffused and made more uniform or if the top cover comprises a colored material the emitted light is colored. At the same time, light emitted by the LED light source shines onto the light affecting piece and is affected by the light affecting piece. For example, if the light affecting piece comprises an opaque material the light is blocked. If the light affecting piece comprises a colored material the light is colored.

In some embodiments of the present invention using the illuminated emblem 100 of FIGS. 7a-7B and the bearing module 180 of FIG. 6, the bearing module 180 is positioned under the back cover 115 so that the entire illuminated emblem 100 rotates. In some other embodiments the bearing module 180 is positioned between the back cover 115 and the top cover 110 so that only the top cover 110 with the light affecting pieces 150 rotates.

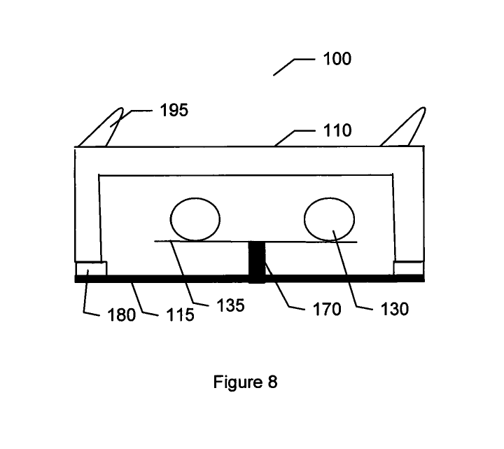

Refer to FIG. 8, which is a drawing illustrating a cross sectional view of a rotatable illuminated emblem according to an embodiment of the present invention.

In the embodiment illustrated in FIG. 8 the illuminated emblem 100 is a rotatable illuminated emblem. A bearing module 180 is positioned between the top cover 110 and the back cover 115. The bearing module 180 allows the top cover 110 to rotate or spin while the back cover 115 is stationary. The top cover 110 is provided with a plurality of fins 195 for enhancing rotation of the top cover 110. For example, as the vehicle speeds up the top cover 110 will rotate at an increased speed. The speed or direction of rotation is controlled by the design of the fins 195. For example, spacing between fins, angle of fins, and shape of fins affect how much wind is caught by the fins.

In this embodiment the at least one LED light source 130 further comprises a printed circuit board PCB 135 for controlling operation of the LEDs 130. The PCB 135 is mounted to the back cover 115 or the vehicle by a fastener 170. Therefore, the LEDs 130 do not rotate and electrical wiring to the PCB 135 is simplified.

Utilizing the effects achievable by the fins 195, rotation of the top cover 110, the shape and material of the light affecting pieces 150, the PCB 135 controlling the LEDs 130, and the color of the LEDs 130 numerous effective light and pattern effects are achieved.

As a result, the illuminated emblem of the present invention is far superior to any conventional vehicle emblems.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An illuminated vehicle emblem comprising:
a transparent layer;
a diffusion layer on the transparent layer; and
at least one light emitting diode light source beneath the diffusion layer.

2. The illuminated vehicle emblem of claim 1, further comprising:
a color layer beneath the transparent layer.

3. The illuminated vehicle emblem of claim 1, further comprising:
a color layer above the transparent layer.

4. The illuminated vehicle emblem of claim 1, the diffusion layer formed by a sputtering process.

5. The illuminated vehicle emblem of claim 1, the diffusion layer positioned above the transparent layer.

6. The illuminated vehicle emblem of claim 1, the diffusion layer positioned below the transparent layer.

7. The illuminated vehicle emblem of claim 1, further comprising:
a solar power source for providing power to the at least one light emitting diode light source.

8. The illuminated vehicle emblem of claim 1, further comprising:
a bearing module under the transparent layer for allowing rotation of the transparent layer or the color piece or both the transparent layer and the color piece.

9. The illuminated vehicle emblem of claim 1, the at least one light emitting diode light source positioned under the transparent layer.

10. The illuminated vehicle emblem of claim 1, the at least one light emitting diode light source positioned on a side of the transparent layer.

11. The illuminated vehicle emblem of claim 1, further comprising:
at least one color piece above the transparent layer; and
at least one fastener for holding the at least one color piece and the transparent layer together.

12. An illuminated vehicle emblem comprising:
a transparent layer;
a diffusion layer on the transparent layer;
at least one light emitting diode light source below the diffusion layer;
at least one color piece above the transparent layer; and
at least one fastener for holding the at least one color piece and the transparent layer together.

13. The illuminated vehicle emblem of claim 12, further comprising:
a color layer beneath the transparent layer.

14. The illuminated vehicle emblem of claim 12, further comprising:
a color layer above the transparent layer.

15. The illuminated vehicle emblem of claim 12, the diffusion layer formed by a sputtering process.

16. The illuminated vehicle emblem of claim 12, the diffusion layer formed above the transparent layer.

17. The illuminated vehicle emblem of claim 12, the diffusion layer formed below the transparent layer.

18. The illuminated vehicle emblem of claim 12, further comprising:
a solar power source for providing power to the at least one light emitting diode light source.

19. The illuminated vehicle emblem of claim 12, further comprising:
a bearing module under the transparent layer for allowing rotation of the transparent layer or the color piece or both the transparent layer and the color piece.

20. The illuminated vehicle emblem of claim 12, the at least one light emitting diode light source positioned under the transparent layer.

21. The illuminated vehicle emblem of claim 12, the at least one light emitting diode light source positioned on a side of the transparent layer.

22. An illuminated vehicle emblem comprising:
a back cover for protection from weather;
a top cover attaching to the back cover;
at least one light emitting diode disposed between the top cover and the bottom cover; and
at least one light affecting piece attaching to the top cover.

23. The illuminated vehicle emblem of claim 22, where the top cover comprises a transparent, semi-transparent, or translucent material.

24. The illuminated vehicle emblem of claim 22, where the top cover comprises a colored material for affecting emitted light color.

25. The illuminated vehicle emblem of claim 22, where the at least one light affecting piece comprises a semi-opaque or opaque material.

26. The illuminated vehicle emblem of claim 22, where the at least one light affecting piece blocks light, colors light, or affects brightness of the light emitted by the at least one LED light source.

27. The illuminated vehicle emblem of claim 22, further comprising:
a solar power source for providing power to the at least one light emitting diode light source.
